(19) United States
(12) Patent Application Publication
(10) Pub. No.: US 2013/0160405 A1
(43) Pub. Date: Jun. 27, 2013

(54) METHOD AND DEVICE FOR TREATING CONTAINERS

(71) Applicants: Katrin Preckel, Gelsenkirchen (DE); Martin Schach, Bochum (DE); Gernot Keil, Braunweiler (DE); Markus Reiniger, Monchengladbach (DE)

(72) Inventors: Katrin Preckel, Gelsenkirchen (DE); Martin Schach, Bochum (DE); Gernot Keil, Braunweiler (DE); Markus Reiniger, Monchengladbach (DE)

(73) Assignee: KHS GmbH, Dortmund (DE)

(21) Appl. No.: 13/819,446

(22) PCT Filed: May 19, 2011
(86) PCT No.: PCT/EP11/02502

§ 371 Date: Feb. 27, 2013

(30) Foreign Application Priority Data
Sep. 2, 2010 (DE) 10 2010 044 244.5

(51) Int. Cl. B05D 3/06

(52) U.S. Cl. CPC B05D 3/067; B05D 3/06
USPC 53/452; 427/532; 427/552; 427/553; 118/620

(57) ABSTRACT

A method for treating containers in which, at a treatment station, the containers are provided on container outer surfaces thereof with a print that including a colorant. The colorant can be dye or ink. The method includes, at a treatment station, processing the colorant by irradiating the containers with non-thermal energy radiation. Processing the colorant includes drying or curing it. The method also includes decontaminating a region of the containers with the same radiation, either by disinfecting or sterilizing it. The region includes either or both a container opening and a container inner surface.

The invention relates to a method according to the preamble of claim 1 and to a device according to the preamble of claim 13.

“Containers” in the sense of the invention are in particular cans, bottles, tubes, pouches made of metal, glass and/or plastic, as well as other packaging containers suitable for filling liquid or viscous products for a pressurised filling or for a pressureless filling.

The expression “treating containers” in the sense of the invention is to be construed as meaning in particular the printing including the digital printing of the containers on their container outer surface using at least one printing dye, preferably polychrome printing using printing dyes of different hues, the drying or curing of the at least one printing dye, preferably by crosslinking the at least one printing dye, as well as the sterilising or disinfecting of the containers at at least one container region at which sterilisation is necessary, while at the same time taking into account the complete process sequence for example within a container filling installation and/or taking into account the condition of the containers to be treated and/or taking into account the production method of these containers, for example from plastic, e.g. PET by blow moulding.

“Printing” in the sense of the invention is to be construed quite generally as the applying of one of more printed images or prints, in particular also multi-colour printed images or prints, to the respective container outer surface and irrespective of the printing method. The printing is carried out preferably using print heads known to the skilled person and working according to the inkjet method, and which are also described in DE 10 2006 001 223 A1. The containers are printed using a printing dye which is dried or cured by energy input, i.e. by heat and/or UV radiation and/or microwave radiation and/or electron radiation, preferably by crosslinking.

The expression “non-thermal or substantially non-thermal energy radiation” in the sense of the present invention is to be construed as meaning an energy radiation which contains no or very few components of thermal or infrared radiation (IR radiation). In this sense, non-thermal or substantially non-thermal energy radiation is above all UV radiation as well as beta or electron radiation or microwave radiation.

For the purpose of the invention the expression “substantially” means variations from the respective exact value by +/−10%, preferably by +/−5% and/or variations in form of changes insignificant for the function.

The direct printing of bottles or other containers and in particular the direct printing of plastic or PET bottles immediately after their manufacture in a stretch- or blow-moulding machine from preheated preforms and the drying or curing of the respective printing dye or print by irradiating the printed containers with UV radiation, electron radiation, microwave radiation or heat radiation/infrared radiation (DE 10 2006 001 223 A1) is known.

The disinfecting or sterilising of the containers by energy input or by treatment with an energy radiation, namely with UV radiation, electron radiation, electron radiation [sic], microwave radiation and thermal radiation or infrared radiation as well as by plasma discharge before they are filled with a filling material is also known.

The disadvantage of the known technology is that separate, complex and costly methods and devices are necessary for the drying or curing of the prints and for the disinfecting or sterilising of the containers.

It is the object of the invention to propose a method for the treatment of containers in which the drying or curing of the at least one printing dye or of the respective print as well as the disinfecting or sterilising of the containers is possible with less complexity. A method according to claim 1 is configured to resolve this object. A device for treating containers is the subject-matter of claim 13.

A particularity of the inventive method consists in the fact that at least the drying of the at least one printing dye applied to the respective container or of the corresponding print as well as the disinfecting or sterilising of the containers is effected with one and the same type of energy radiation, preferably with one and the one and the same type of type of non-thermal or substantially non-thermal energy radiation and again preferably with UV radiation.

For sterilising, the particular container region which is to be sterilised is directly irradiated with the energy radiation. It is theoretically possible here to sterilise only the mouth or opening region of the containers by irradiating with the energy radiation, especially when the containers are already in a sterile condition when they are fed to an installation and a contamination of the container mouth region only is to be feared from handling within the installation. Preferably however, a complete disinfection or complete sterilisation of the containers is effected, among other things on the entire inner surface of the container and on the mouth region. Even with containers that are made from a transparent material such as plastic (for example PET), the irradiation of the container regions that are to be sterilised is preferably effected not through the wall of the container so as to achieve optimum sterilisation with as little radiation energy as possible in this way.

If UV radiation is used as the energy radiation for example, as is the preferred option for the invention, then this radiation together with the photoinitiators present in the respective printing dye (printing ink) form radicals which then bring about a crosslinking of the monomers and/or oligomers of the printing dye for the curing of said dye. Using UV radiation to irradiate the container regions that are to be sterilised will cause damage to the DNA or RNA molecules of any bacteria present in those regions, thereby preventing cell division and achieving the desired sterilisation.

In a preferred embodiment of the inventive method, the drying or curing of the at least one printing dye and the sterilising of the containers is effected at one and the same treatment station, but at least in one and the same treatment or work module or in one and the same work machine or workstation displaying a plurality of treatment stations. Carrying out the drying or curing process of the at least one printing dye and the sterilisation of the containers with one and the same type of energy radiation, preferably UV radiation, has considerable advantages:
Chemicals can be dispensed with during container sterilisation, so that no chemical residues are left behind in and/or on the sterilised containers.
No volatile organic constituents are formed during the drying or curing of the at least one printing dye with energy radiation, preferably with UV radiation. In addition, basically no thermal energy which may harm the containers is needed, even though a certain proportion of thermal energy in addition to the treatment with the UV radiation or other non-thermal energy radiation may be expedient for shortening in particular the drying or curing process of the at least one printing dye.
The drying or curing of the at least one printing dye and the sterilisation of the containers by energy radiation, in particular by UV radiation, are moreover rapid processes which make it possible to optimally sterilise the treated surfaces of the containers in fractions of seconds, at most in a few seconds, and to cure the at least one printing dye in fractions of seconds, at most in a few seconds.
If as is proposed in a preferred embodiment of the invention the drying or curing of the at least one printing dye and the sterilising of the containers takes place in a common treatment station and preferably simultaneously as well, then a separate sterilisation process is avoided and the cooling of the sources for the energy radiation, in particular the cooling of UV lamps and their control system, can be provided in one module, for example in a module of the bottling line.
When UV radiation is used, this radiation is only worked with in a partial region of the overall installation. It is only here or at the corresponding treatment module that screening is required to avoid a UV radiation burden on the operators or operating personnel.
If the same UV lamps or tubes are used for the drying or curing of the at least one printing dye as are used for the sterilising of the containers, then they can be purchased in greater quantities, generating considerable cost benefits both for the manufacturer and for the user of an installation,
There is no increase in temperature to damage the containers. Any IR radiation components that are generated by the radiation source can be filtered out, especially when UV radiation is used.

Low-pressure Hg radiators, medium-pressure Hg radiators, excimer radiators, exciplex radiators, amalgam lamps, LEDs, Xenon lamps etc. can be used as UV lamps. During the treatment the containers are moved by a transport system through a treatment section and/or rotated or swivelled about their container axis.

The container surface that is to be printed preferably undergoes a pretreatment to improve at least the adhesion strength of the print. This pretreatment is effected preferably with UV radiation that splits oxygen molecules in the ambient air with a wavelength of approx. 170 to 200 nm, forming ozone in the process. The latter is then broken down by the UV radiation, forming highly reactive O* radicals which in turn lead to a splitting or oxidation of organic molecules on the container surface. The UV radiation also forms other radicals such as COO*, *OH, CO* and COOH* which disturb the symmetry of the plastics, thereby achieving an overall increase in the surface energy of the plastic containers and hence improving the strength of the printing dye or print.

In a preferred embodiment of the invention, the drying or curing of the at least one printing dye and/or the sterilising of the containers takes place while exposing the containers to a process gas or a shielding or inert gas, for example N2, CO2, Ar, Kr, Xe or a mixture of these. This process gas, with which the interior of the containers is then also purged, is also used for example to cool the containers during the treatment and/or is cooled down to the extent that the temperature of this process gases is below the temperature of the containers to be treated. What this achieves among other things is that the process gas introduced into the containers is warmed during the treatment by among other things the heat given off by the respective container, and so partly flows out of the container mouth, preventing an ingress into the respective container of oxygen which might harm the filling material filled into the containers.

If the container is filled with a shielding or inert gas and its interior is disinfected by the introduction of a UV radiator, then those UV quanta whose energy is sufficient to dissociate molecular oxygen that would be present inside the container in the case of an air filling can spread to the container wall, otherwise—i.e. in the presence of oxygen—the quanta would only spread a few tenths of a millimetre. These quanta would be lost for bacterial inactivation through being used up in dissociation processes of the dissociating oxygen. Filling a container with inert gas therefore leads to very effective disinfection because short-wave quanta in the range of 240 nm—those which are concerned here—have a more effective action than quanta with wavelengths of more than 240 nm. The effectiveness of the quanta even increases as wavelength decreases.

As an additional improvement in the effectiveness of the disinfection and of the method it has been shown that the inert gas filling should be cooled, since the oxygen in the container's immediate proximity has a desire to diffuse back into the container owing to the presence of a steep concentration gradient of the oxygen's partial pressure in the region of the container opening. This desire by the oxygen to flow into the container can be suppressed so long as a cool gas inside the container warms up to the temperature of the container, expands and then slowly flows out of the container. This effect has been demonstrated both for standing on their head [sic] and with their opening pointing upward, whereby a gas which is some 10 K colder than the container suppresses the diffusion of the oxygen for more than 10 seconds. Even colder gas fillings have an even better effect.

The drying or curing of the at least one printing dye and/or the sterilising of the containers takes place preferably in a low-oxygen inert gas atmosphere formed for example by the afore mentioned process gas or inert gas, i.e. inside an enclosure formed of metal sheets, cages, hoods etc. which contains this low-oxygen atmosphere and isolates it from the surrounding environment. Amongst other things this permits the use of a particularly effective short-wave UV radiation, for example a UV radiation having a wavelength ranging between approx. 170 nm and 280 nm, preferably ranging between approx. 170 nm and 220 nm or ranging from approx. 170 nm to 200 nm for the drying or curing of the at least one printing dye and/or for the sterilising of the containers, i.e. the use of a UV radiation which can only spread a few tenths of a millimetre in ambient air because of the presence of oxygen. In this way the inert gas of the low-oxygen shielding gas atmosphere forms a transmission gas which permits the use of the short-wave UV radiation.

The oxygen's partial pressure in the shielding gas atmosphere is preferably 0.5% maximum, preferably 0.1% maximum of the total pressure of this atmosphere. The advantages of this special method consist therefore in the fact that an absorption of the UV radiation on O2 molecules whose intensity increases with the diminishing wavelength of the UV radiation, as well as ozone formation, are avoided.

During the pretreatment of the container outer surface to improve the adhesion strength of the at least one printing dye or of the print by increasing the surface energy, a disinfection or sterilisation of the outer wall of the container is preferably effected at the same time.

During the treatment the containers are held and/or moved by container carriers or container grippers. The latter are preferably also disinfected by the energy radiation together with the containers and/or there is an additional sterilisation of the container carriers or container grippers after they are uncoupled from the containers. A further option is to design the container carriers or container grippers so that, even with a treatment section which consists of a plurality of transport elements succeeding one another in a transport direction of the containers, each container carrier or container gripper remains on the respective container at least over the whole treatment section and is only connected to the respective transport direction on that part of the transport path formed by this apparatus [sic]. At the end of the treatment each container carrier or container gripper is uncoupled from the respective container and then returned sterilised to the start of the treatment section or to the start of an installation which exhibits the said treatment section.

Further embodiments, advantages and possible applications of the invention arise out of the following description of embodiments and out of the figures. All of the described and/or pictorially represented attributes whether alone or in any desired combination are fundamentally the subject matter of the invention independently of their synopsis in the claims or a retroactive application thereof. The content of the claims is also made an integral part of the description.

The invention is explained in detail below through the use of embodiment examples with reference to the figures. In the figures:

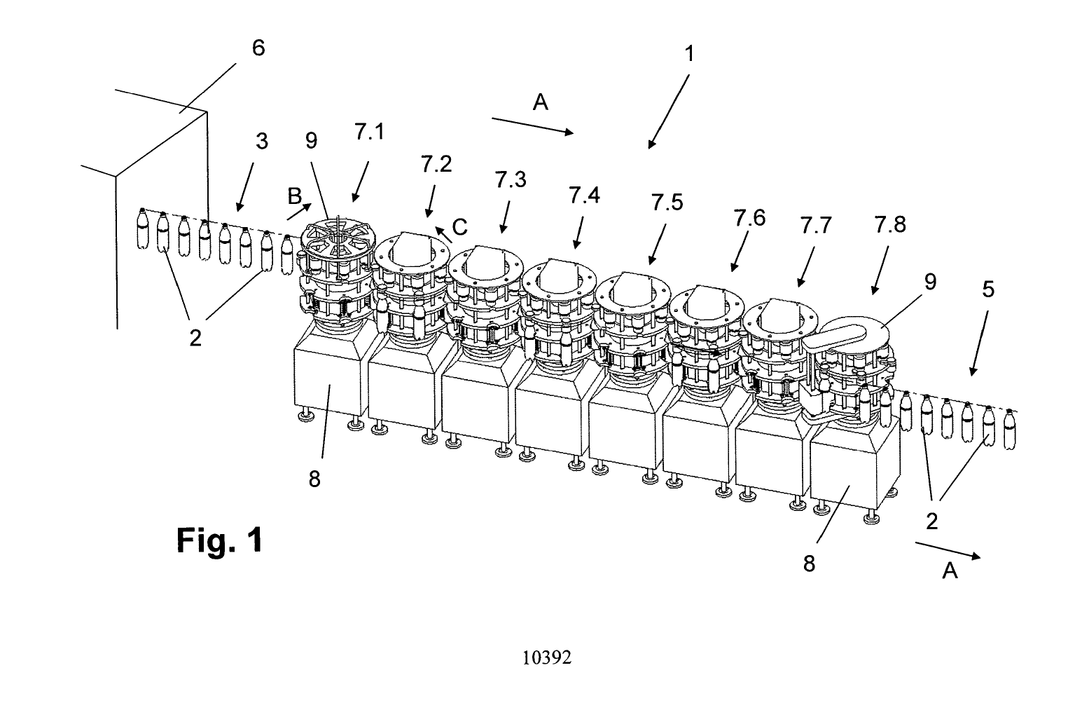

FIG. 1 shows a simplified perspective depiction of an installation for the treatment of containers in the form of bottles (PET bottles in this case) in simplified perspective depiction;

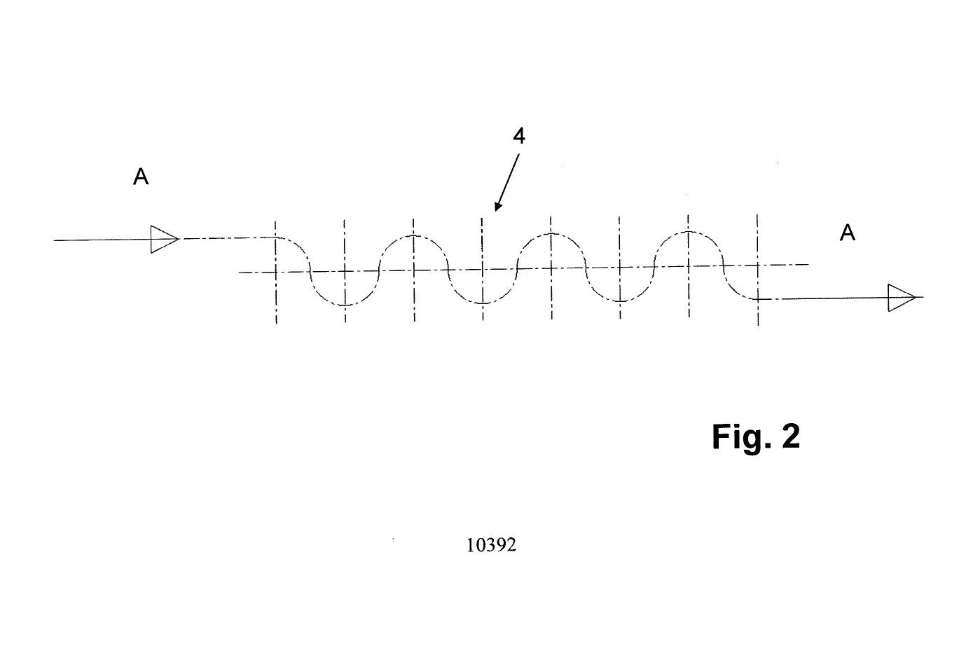

FIG. 2 shows a schematic depiction of the transport path of the respective container through the installation of FIG. 1;

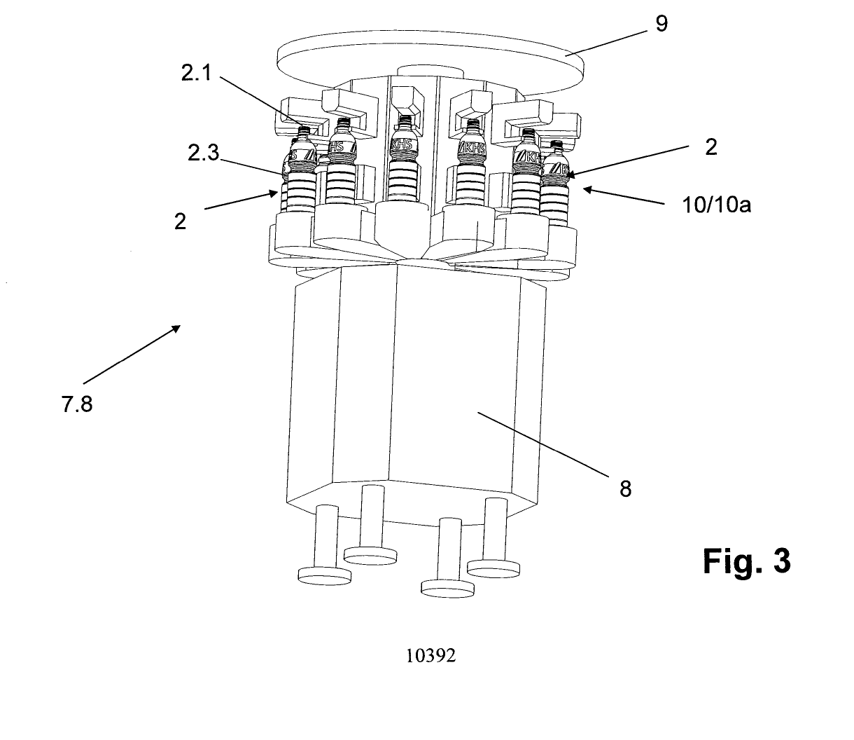

FIG. 3 shows a perspective depiction of one of the treatment modules of the installation of FIG. 1, in this case for example for the simultaneous curing of the print applied to the respective bottle and for sterilising the bottles in the region of at least their bottle mouth;

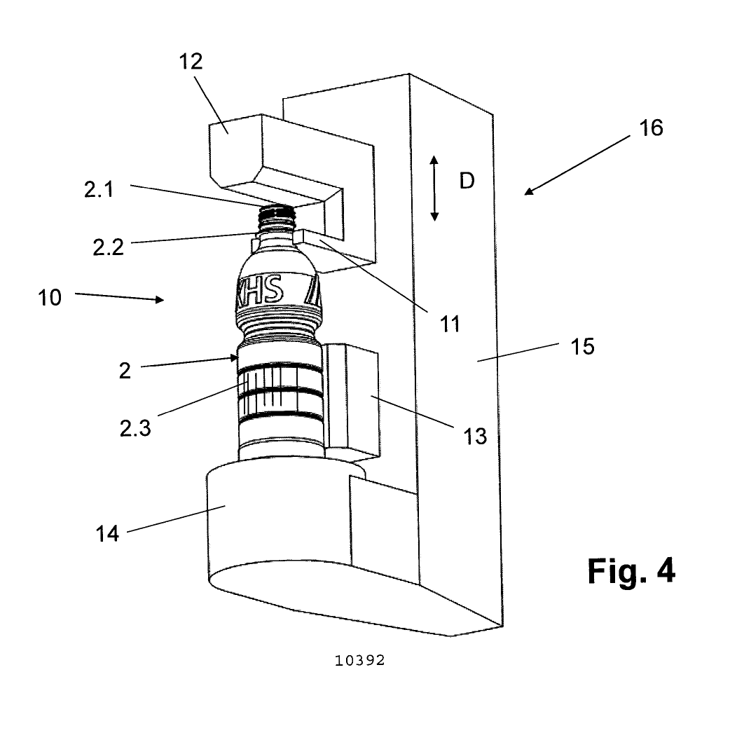

FIG. 4 shows a schematic, perspective depiction of one of the treatment positions of the treatment module of FIG. 3;

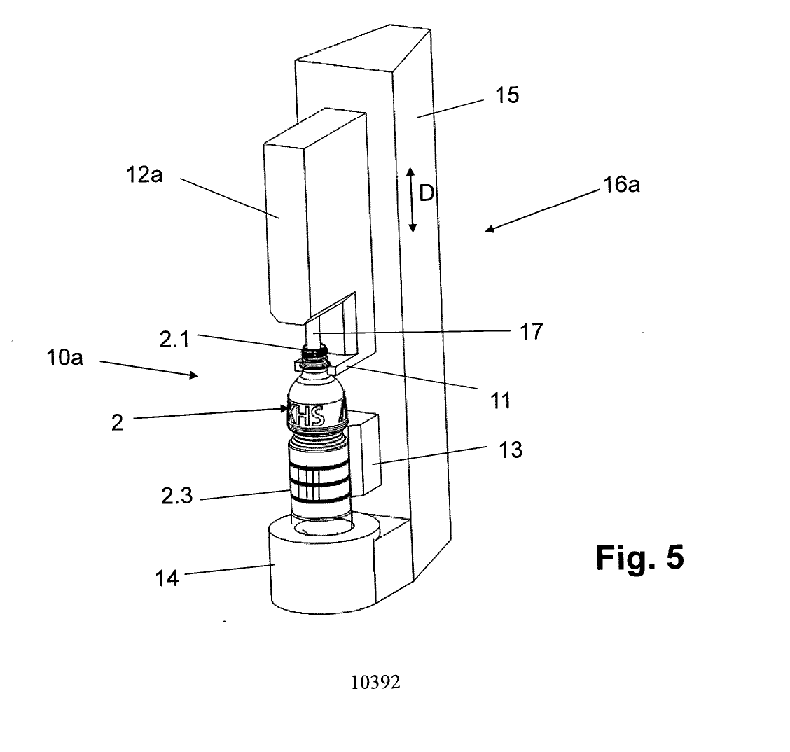

FIG. 5 shows a depiction similar to FIG. 4 but in another embodiment of the treatment module;

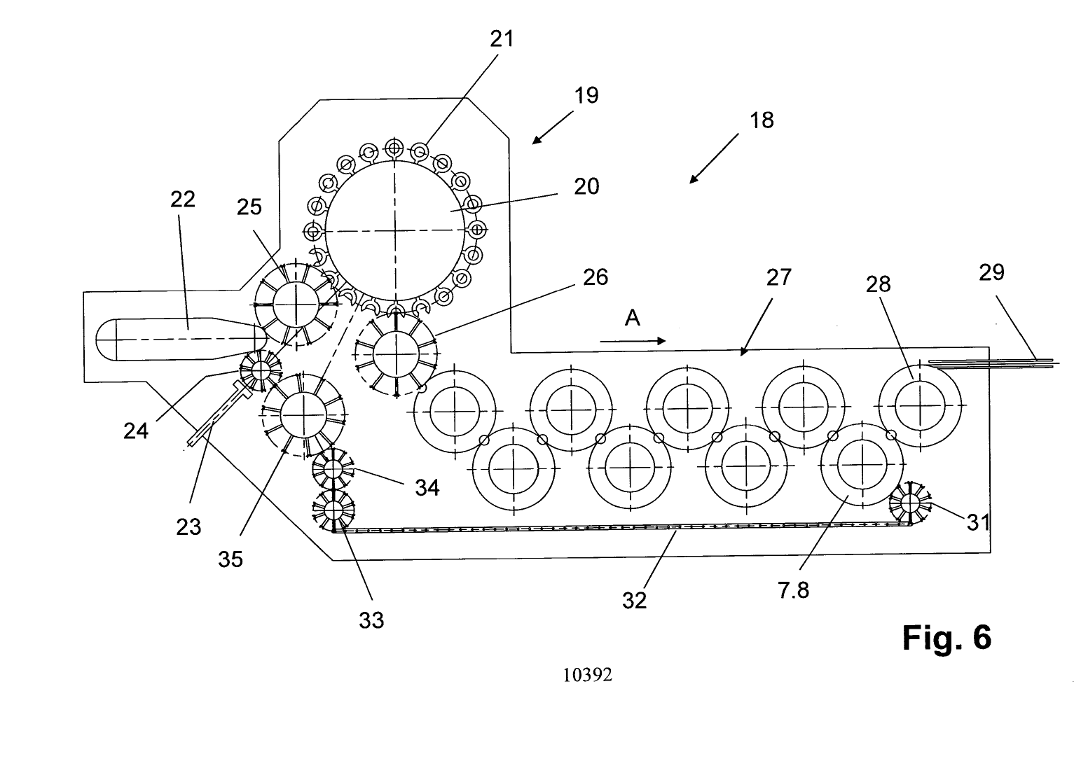

FIG. 6 shows a simplified depiction in plan view of an installation for producing the containers in the form of plastic bottles, for example in the form of PET bottles by stretch or blow moulding, and also for the subsequent treating of the produced containers;

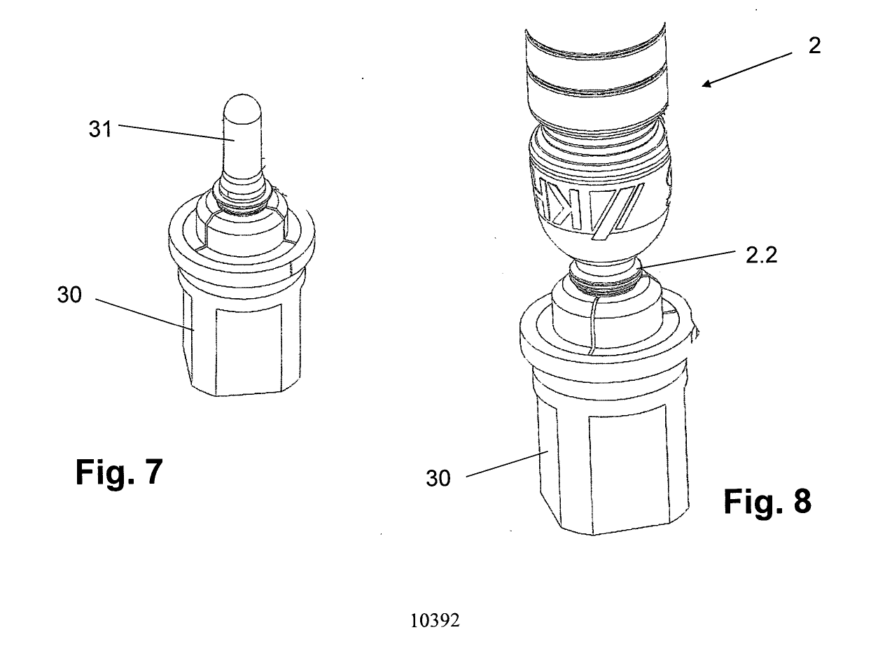

FIGS. 7 and 8 show a centering and holding element for use with the device of FIG. 6 with a preform and/or a partially depicted bottle.

The treatment section generally labelled 1 in FIG. 1 is used for treating containers in the form of bottles 2 which an outer conveyor 3 feeds to installation 1 hanging, i.e. held suspended by a flange or neck ring 2.2 formed below the respective bottle opening 2.1, and in a transport direction indicated by arrows A, in which direction bottles 2 are also moved through treatment section 1 along a wave-shaped or meander-shaped transport path 4 (FIG. 2) and in which treated bottles 2 leave treatment section 1 at a container outlet, again suspended from an outer conveyor 5. Outer conveyor 5 conveys bottles 2 to a further use, for example to a filling machine. Bottles 2 are produced for example in the manner known to the skilled person from preforms by stretch or blow moulding in a blow-moulding machine which is indicated schematically only by block 6 in FIG. 1. The method is of course not confined to PET bottles but can of course be used equally for other plastic bottles such as for example PE, PP, PLA or PHB bottles.

In the depicted embodiment, treatment section 1 is modular in structure, consisting of a plurality of treatment modules, i.e. in the depicted embodiment of a total of eight treatment modules 7.1-7.8 which in the order of their reference numbers are provided succeeding one another in transport direction A in such a way that bottles 2 are passed from treatment module to treatment module, moving along transport path 4 shown in FIG. 2 in the process.

Treatment modules 7.1-7.8 each consist of an identical base unit having a lower module housing or machine housing 8 upon whose top is provided a rotor 9 which can be driven to rotate about a vertical machine axis and on whose periphery are formed a plurality of treatment stations to which bottles 2 are transferred at a container inlet of treatment module 7.1-7.8 and after undergoing treatment there, which takes place over an angular range of the rotary motion of respective rotor 9, are individually passed on to a treatment station of a subsequent treatment module 7.2-7.8 or to outer conveyor 5. Rotors 9 of treatment modules 7.1-7.8 which succeed one another in transport direction are driven by a corresponding controller synchronously and with the same rotary or angular speed but in opposite directions, as indicated by arrows B and C in FIG. 1.

The treatment stations of treatment modules 7.1-7.8 are matched to the respective treatment by corresponding units and/or functional elements provided in the base unit. In the case of the embodiment depicted in FIG. 1, the treatment positions of treatment module 7.1 are configured for a pretreatment of bottles 2 which is described in more detailed below. Treatment modules 7.2-7.7 act as print modules for the printing, preferably digital printing, of bottles 2 on their outer surfaces, i.e. for applying polychrome printed images or prints to the outer surface of bottles 2, preferably also to different regions of that outer surface. Accordingly the treatment positions of treatment modules 7.2-7.7 are equipped with printing heads (not shown in FIG. 1), for example with printing heads that operate by the inkjet method and that are known to the skilled person.

Treatment module 7.8 acts as a drying and sterilisation module for the drying or curing of the prints or corresponding printing dye or printing ink applied to bottles 2, and at the same time for the sterilising of bottles 2, at least on a partial region thereof on which such sterilising is necessary because of the production of bottles 2 and/or of the source materials used for their production and/or of the handling of bottles 2 after their production etc.

In the depicted embodiment, both the curing of the print and the sterilising with the use of UV radiation, in each case with a UV spectrum which is optimised in the manner described above for curing the printing dye and for killing bacteria, is effected with for example a UV light spectrum that exhibits a clearly pronounced maximum at a wavelength of approx. 270 nm.

Treatment module 7.8 is shown in detail in FIGS. 3 and 4. The treatment stations identified in these Figures by the reference number 10 each comprise a fork-like or gripper-like container carrier 11 for the suspended holding and support of bottle 2 by its neck ring 2.2. Above the container carrier 11 and hence above opening 2.1 of bottle 1 present at treatment station 10 is arranged a first UV light emitting apparatus 12 having at least one UV lamp which is directed downwards i.e. onto the region of bottle opening 2.1. A second UV light emitting apparatus 13 is also provided which lies radially on the inside relative to the machine axis and which emits light onto the peripheral or envelope surface of bottle 2. This second emitting apparatus 13 is used for curing or drying the printing dye. There is also provided a turntable 14 which can be rotated by a drive (not shown) about its vertical turntable axis and by which bottle 2 is set in rotation.

Container carrier 11, apparatuses 12 and 13 and turntable 14 are provided on a housing 15 on which for example the unit formed by container carrier 11 and apparatus 12 can be moved vertically up and down under control (double arrow D) and in which among other things the components needed to operate and/or cool the UV lamps of apparatuses 12 and 13 are accommodated. Container carrier 11, apparatuses 12 and 13, turntable 14 and housing 15 furthermore constitute a complete assembly unit 16 which as such is provided on rotor 9 and which each form one of the treatment stations of treatment module 7.

For a smooth acceptance and delivery of a bottle 2 at the transfer region between treatment modules 7.7 and 7.8 and at the transfer region between treatment module 7.8 and outer conveyor 5, container carrier 11 and apparatus 12 are each raised and—during the treatment—lowered such that respective bottle 2 now stands upright on turntable 14 with its bottle base facing away from bottle opening 2.1, and is rotated with turntable 14 about the vertical turntable axis/the bottle axis that is arranged on the same axis as the turntable axis, in particular for a treatment of the whole bottle periphery with the UV radiation emitted by apparatus 13. At this stage, container carrier 11 now only serves to steady upright bottle 2 from falling over.

It was assumed above that the apparatus comprising container carrier 11 and apparatus 12 can be controlled to move up and down. It is also basically possible that instead of or as well as this, turntable 14 is controlled to move vertically up and down so as to facilitate, in the manner mentioned above, a smooth transfer and delivery of bottles 2 respectively to and from respective treatment station 10 on the one hand and on the other the rotation of bottles 2 about their vertical bottle axis during the treatment.

Because bottles 2 are UV-sterilised only in the region of their bottle mouth or bottle opening 2.1 at treatment stations 10, this treatment assumes that bottles 2 are substantially sterile after they are manufactured or that they are formed from sterile preforms, and that further handling on the transport path to treatment section 1 or within treatment section 1 has contaminated them only in the region of their bottle mouth.

As a further embodiment of the invention, FIG. 5 shows in a depiction similar to FIG. 4 a treatment station 10a which differs substantially from treatment station 10 in that apparatus 12a provided above container carrier 11 and emitting UV light or UV radiation is configured for a sterilisation at least of the entire inner surface of respective bottle 2, and which for this purpose and during the treatment extends through bottle opening 2.1 into the interior of treated bottle 2 with a UV lamp or with a light guide 17 to which the UV radiation from a UV lamp is applied. With this embodiment too, the sterilising of respective bottles 2 and the curing or drying of printed image 2.4 takes place at one and the same treatment station 10a of treatment module 7.8, and preferably simultaneously.

This embodiment of treatment station 10a takes account of the circumstance that even with transparent bottles 2, i.e. bottles 2 that are produced from a translucent or crystal-clear material or plastic, for example PET, when a UV-radiation-emitting source is disposed outside bottle 2 there is such strong absorption of the UV radiation as it passes through the wall of bottle 2 that adequate sterilisation is not possible, at least not with an economically acceptable UV power and within a treatment time which is acceptable among other things in terms of the necessary performance of treatment section 1.

Treatment module 10a can also be embodied such that both a sterilisation of bottles 2 on the bottle's inner surface and an intensive sterilisation on the bottle's outer surface, in particular in the region of bottle opening 2.1 and in particular by means of UV radiation, is achieved.

It has been assumed above that by lowering container carrier 11 or raising bottle turntable 14, respective bottle 2 is uncoupled from container carrier 11 to allow bottle 2 to be rotated about its bottle axis during the treatment. This uncoupling can of course also be achieved by other means, for example by an appropriately configured container carrier releasing respective bottle 2 to be rotated about its bottle axis during the treatment. It is also possible for the container carrier to be configured such that it actually brings about the rotation of respective bottle 2 during the treatment.

Treatment module 7.1 is configured for a pretreatment of bottles 2, in particular for a pretreatment of bottles 2 on their surface which is to be printed, so as to achieve an improved adhesion of the printing dye. This pretreatment is effected by irradiating with UV radiation those surfaces that are to be subsequently printed. The improvement in the adhesion of the printing dye is due among other things to the fact that the UV radiation, in particular having a wavelength of less than 240 nm, splits oxygen molecules close to the treated surfaces, so bringing about the formation of ozone which then together with the oxygen absorbs UV quanta that have wavelengths below 240 nm. As a result (and in addition to radicals such as COO*, *OH, CO*, COOH*) radicals are formed on the plastic chains of the material of bottles 2 where they bring about localised changes to the symmetry of the molecular structure, thereby increasing the surface energy increases and improving the adhesion strength and wettability of the surfaces that are to be printed with printing dye. This pretreatment of bottles 2 with the UV radiation is preferably accompanied by a sterilisation or disinfection of the outer surface of bottles 2.

For this pretreatment, the treatment stations of treatment module 7.1 are configured for example similarly to the treatment stations 10 or 10a, though without the UV-radiation-emitting apparatus 12 and 12a respectively.

Other treatment methods and appropriately configured treatment stations for improving the adhesion strength and wettability of the printed surfaces of bottles 2 are also possible for treatment module 7.1. For example, methods and correspondingly configured treatment stations in which a surface silicatising of bottles 2 by pyrolysis, for example flame pyrolysis, is carried out at least on the surface regions which are to be subsequently printed, and in such a way that a thin but very dense and firmly adhering silica layer with high surface energy and hence with high adhesion strength is generated for the respective printing dye on the outer surface of respective bottle 2. This is achieved for example by flame treatment of bottles 2 using a suitable gas, for example propane and/or butane in the presence of an organic silicon compound (e.g. silane).

Especially beneficial results can be achieved in particular when the UV sterilisation and the UV curing of the printing dye, i.e. the treatment of bottles 2 at treatment stations 10 or 10a of treatment module 7.8, takes place in a low-oxygen, sterile inert gas atmosphere e.g. from N2 and/or CO2 and/or He and/or Ar and/or Kr and/or Xe. It has been shown that atmospheric oxygen inhibits the crosslinking reaction and/or curing of the common polymer printing dyes. The curing or drying times can be reduced and the hard-drying of the printing dye improved by using a low-oxygen shielding or inert gas atmosphere. Ozone formation is moreover avoided when using a shorter-wave UV radiation which has a wavelength significantly below 240 nm and which is optimal for UV sterilisation. The inert gas of the shielding or inert gas atmosphere also acts as a transmission gas which makes it possible to use a very short-wave UV radiation for a rapid and high quality UV sterilisation, for example a UV radiation within the wave range of 170 to 280 nm, preferably within the range of 170 to 220 nm. This would not be possible in an atmosphere containing oxygen because here a UV radiation having a within the range of 170 to 200 nm [sic] can only spread a few 1/10 mm at best. Especially in the case of a UV radiation having a wavelength of 200 nm, the oxygen's partial pressure in the shielding gas atmosphere or inert gas atmosphere should be at most 0.5%, preferably 0.1% of total pressure.

When a low-oxygen shielding gas or sterile gas atmosphere is used during UV sterilisation and UV curing, corresponding treatment stations 10 and 10a are disposed in an enclosure into which the shielding or inert gas is applied preferably with a certain positive pressure so as to produce at the inlet and outlet of this enclosure an inert gas flow out of the housing and into the surrounding area, so preventing an ingress of oxygen into the enclosure.

It is also possible to charge or to purge the surface of bottles 2 and/or the interior space of the bottle during UV sterilisation and UV curing with a preferably cooled process gas or inert gas. Among other things this minimises the thermal burden on bottles 2 during UV sterilisation and UV curing, in particular also by emitted infrared components. A further substantial advantage is gained when the inert process gas introduced into respective bottle 2 exhibits a temperature which is significantly below that of bottle 2 such that the process gas in bottle 2 initially exhibits a higher density, then slowly heats up to the bottle temperature and as it expands partly flows out of bottle 2, so preventing an ingress of oxygen into respective bottle 2.

It was assumed above that the UV sterilisation and UV curing takes place in a part of a whole installation which precedes the filling machine, namely in treatment module 7.8 of treatment section 1. Instead of or in addition to this, it is also possible to incorporate the UV sterilisation and/or UV curing or at least one corresponding treatment station in a filling machine, in the manner for example in which a UV sterilisation and/or sterilisation of the filling material introduced into respective bottle 2 is carried out in at least one treatment station, as is possible in particular with mineral waters of table waters.

It was also assumed above that the individual process steps of pretreatment, printing and UV sterilisation and UV curing each take place in separate processing modules 7.1-7.8. It is off course possible to execute all or some of these treatment steps each in a workstation or work machine. Yet another possibility, in particular in the case of polychrome printing, is to carry out—in one or a plurality of additional work steps—a predrying of the printing dye before a further printing dye is applied.

It has been assumed above that bottles 2 are conveyed through treatment section 1 standing upright, i.e. with their bottle opening 2.1 pointing up and their bottle axis vertically oriented, and that, in particular, the treatment in treatment module 7.8 also takes place in this position. It is however also possible in principle to effect a treatment of bottles 2 in a different attitude, for example in an upended position, i.e. with bottle opening 2.1 pointing down.

The very simplified functional representation and plan view in FIG. 6 show an installation 18 for producing bottles 2 by blow-moulding and for the subsequent printing and UV sterilising and UV curing respectively of bottles 2 and print 2.4. Installation 18 comprises among other things a rotary blow-moulding machine 19 which exhibits a plurality of blow moulds 21. Blow-moulding machine 19 exhibits a rotor 20 which can be driven to rotate about a vertical machine axis, with blow moulds 21 being disposed on the side or top of rotor 20. During normal operation, the heated preforms are fed to blow moulds 21 over a transport section exhibiting a preheating section 22; the transport section exhibits among other things conveyor 23 and the two transport star wheels 24 and 25.

Bottles 2 which are produced with blow-moulding machine 19 are transferred by a transport star wheel 26 to a treatment section 27 which for example is the same as treatment section 1 and on which bottles 2 are pretreated on their bottle outer surface and if required sterilised with UV radiation, printed and then also subjected to a UV sterilisation and a curing of the respective print or printed image with UV radiation. Bottles 2 that are treated in this way are fed via an outlet star wheel 28 and an outer conveyor 29 to a filling machine. The transport of bottles 2 from blow-moulding machine 19 to treatment section 27, through the treatment section or through the various treatment modules or workstations of this treatment section as well as the transport on conveyor 28 takes place in upended form, i.e. with bottle opening 2.1 pointing down. The basic difference between treatment section 27 and treatment section 1 is that instead of container carriers 11 which in the case of treatment section 1 are each a permanent part of treatment stations 10 and 10a of individual treatment modules 7.1-7.8, with installation 18 grippers or centering and holding elements 30 (FIGS. 7 and 8) are used on which preforms 31 after their transfer from conveyor 23 and subsequently also bottles 2 after blow-moulding are already held centered, and with which bottles 2 are conveyed as far as the workstation or as far as the treatment module which corresponds to treatment module 7.8 and in which the UV sterilising of bottles 2 takes place. It is only after the transfer of respective bottle 2 from workstation 7.8 to outlet star wheel 28 that respective bottle 2 is released from centering and holding element 30 which, sterilised in workstation 7.8, is then returned over a transport section indicated in FIG. 6 by elements 32-36 to blow-moulding machine 19 or to transport star wheel 24 to pick up a further preform 31. The fundamental advantage of this is that each preform 31 and therefore each bottle 2 is held on one and the same sterilised or disinfected centering and holding element 30 from the outset.

Each centering and holding element 30 is configured so as to facilitate a controlled swivelling or rotating of respective bottle 2 about the bottle axis during its treatment, in particular during UV sterilising or UV curing. To this end, each centering and holding element 30 is provided with an actuator drive or can be coupled to such a drive of the respective treatment station.

Centering and holding elements 30 are configured so that respective bottle 2 is held in the region of its bottle mouth 2.1 e.g. by clamping and/or with clamping jaws.

The invention has been described hereinbefore by reference to embodiments. It goes without saying that numerous variations as well as modifications are possible without departing from the inventive concept underlying the invention.

### LIST OF REFERENCE CHARACTERS

1 Treatment section

2 Bottle

2.1 Bottle opening

2.2 Neck ring

2.3 Print

3 Outer conveyor

4 Transport path through treatment section 1

5 Outer conveyor

6 Blow-moulding machine

7.1-7.8 Treatment module

8 Machine housing or frame

9 Rotor

10, 10a Treatment station

11 Container carrier

12, 13 Device emitting UV radiation

14 Turntable

15 Housing

16,16a Assembly unit

17 UV lamp or light guide

18 Installation

19 Blow forming machine

20 Rotor

21 Blow mould

22 Preheating section or preform oven

23 Conveyor

24, 25, 26 Transport star wheel

27 Treatment section

28 Bottle outlet

29 Outer conveyor

30 Gripper or centering and holding element

31 Preform

32-36 Transport section

A Transport direction

B,C Direction of rotation of rotor 9

D Stroke of container carrier 11

1-17. (canceled)

18. A method for treating containers in which, at a treatment station, said containers are provided on container outer surfaces thereof with at least one print comprising a colorant, said colorant comprising at least one of printing dye and printing ink, said method comprising at a treatment station, processing said colorant by irradiating said containers with non-thermal energy radiation, and, using said non-thermal energy radiation as was used to process said colorant, decontaminating a region of said containers, wherein processing said colorant comprises at least one of drying said colorant and curing said colorant, wherein decontaminating a region of said containers comprises at least one of disinfecting a region of said containers and sterilizing said region of said containers, and wherein said region of said containers comprises at least one of a container opening and a container inner surface.

19. The method of claim 18, wherein said non-thermal energy radiation is selected from the group consisting of electron radiation, microwave radiation, ultra-violet radiation, radiation having a wavelength between 170 and 280 nm, and radiation having a wavelength between 170 and 220 nm.

20. The method of claim 18, further comprising executing the steps of processing said colorant by irradiating said containers with non-thermal energy radiation and decontaminating a region of said containers in at least one of a common method step, a common treatment station, a common workstation of a container treatment line, a common device of a container treatment line, a common workstation of a container treatment installation, and a common device of a container treatment installation.

21. The method of claim 18, further comprising pre-processing said colorant before processing said colorant and before decontaminating said containers, wherein pre-processing comprises at least one of pre-drying and pre-curing.

22. The method of claim 18, further comprising executing said steps of processing said colorant and decontaminating said containers before filling said containers with a filling material and within a container filling line.

23. The method of claim 18, further comprising executing said steps of processing said colorant and decontaminating said containers after filling said containers with a filling material, and within a container filling line.

24. The method of claim 18, further comprising pretreating said container outer surfaces of said containers, at least on regions of said container outer surface to be printed, using said energy radiation that is used for both processing said colorant and decontaminating said containers, thereby improving adhesion strength of said colorant.

25. The method of claim 18, further comprising pretreating said containers, at least on regions of said container outer surface to be printed, by silicatizing, thereby improving adhesion strength of said colorant.

26. The method of claim 25, wherein decontaminating said containers is carried out while carrying out a step selected from the group consisting of processing said colorant and pretreating said container outer surface.

27. The method of claim 18, further comprising at least one of charting and purging said containers with a shielding gas while executing at least one step from the group consisting of processing said colorant and decontaminating said containers, said shielding gas being at a temperature below a temperature of said containers.

28. The method of claim 18, wherein at least one step from the group consisting of processing said colorant and decontaminating said containers comprises carrying out said at least one step in a low-oxygen shielding gas atmosphere having an oxygen partial pressure between 0.5% and 0.1% of a total pressure of said shielding gas atmosphere, wherein said shielding gas atmosphere comprises at least one of nitrogen, carbon dioxide, argon, krypton, xenon, and an inert gas.

29. The method of claim 18, further comprising, using at least one transport element on a transport path of a treatment section, at least one of moving, rotating, and swiveling said containers about container axes thereof while at least one of processing said colorant and decontaminating said containers.

30. The method of claim 18, further comprising, using said type of non-thermal energy radiation, sterilizing a holding structure selected from the group consisting of a centering and holding element, and a container carrier, and temporarily holding said containers on said holding structure.

31. The method of claim 30, further comprising, after a holding structure has released a container, uncoupling said holding structure from a transport system and returning said holding structure, as an independent unit, to an entrance of a treatment section.

32. An apparatus for treating containers, said apparatus comprising a treatment or transport section for said containers, said treatment or transport section comprising a first treatment station for digitally printing on container outer surfaces of said containers using a colorant, a second treatment station for processing said colorant by irradiation of said containers with non-thermal energy radiation, and a decontamination station configured for decontaminating said containers on a container region thereof by irradiating said containers with said non-thermal energy radiation used for processing said colorant, wherein said colorant comprises at least one of printing dye and printing ink, wherein processing said colorant comprises at least one of drying said colorant and curing said colorant, wherein decontaminating said containers comprises at least one of disinfecting and sterilizing said containers, and wherein said container region is selected from the group consisting of a region of a container opening and a region of a container inner surface.

33. The apparatus of claim 32, wherein said decontamination station is provided at said second treatment station.

34. The apparatus of claim 32, further comprising a further treatment station for pre-processing said colorant, wherein pre-processing comprises at least one of pre-drying said colorant, pre-curing said colorant, and pre-treating said containers on regions of said container outer surfaces thereof to improve adhesion strength of said colorant by irradiating said container outer surfaces with said non-thermal energy radiation.

35. The apparatus of claim 32, further comprising a further treatment station for pre-treating said containers on regions of said container outer surfaces thereof to improve adhesion strength of said colorant by surface silicatizing.

36. The apparatus of claim 34, wherein said non-thermal energy radiation is selected from the group consisting of electron radiation, microwave radiation, ultra-violet radiation, electromagnetic radiation having a wavelength ranging from 170 to 280 nm, and electromagnetic radiation having a wavelength ranging from 170 to 220 nm.

37. An apparatus for treating containers, said apparatus comprising a treatment or transport section for said containers, said treatment or transport section comprising means for digitally printing on container outer surfaces of said containers using a colorant, means for irradiating said colorant with non-thermal radiation, and means for decontaminating said containers with on a container region thereof by irradiating said containers with said non-thermal radiation.
